(19) United States
(12) Patent Application Publication
(10) Pub. No.: US 2026/0285042 A1
(43) Pub. Date: Sep. 24, 2026

(54) LIQUID DISCHARGE HEAD AND LIQUID DISCHARGE APPARATUS

(71) Applicants: Yoshihide NIISATO, Kanagawa (JP); Minoru TAGUCHI, Kanagawa (JP)

(72) Inventors: Yoshihide NIISATO, Kanagawa (JP); Minoru TAGUCHI, Kanagawa (JP)

(21) Appl. No.: 19/554,970

(22) Filed: Mar. 3, 2026

(30) Foreign Application Priority Data
Mar. 19, 2025 (JP) 2025-046063

(51) Int. Cl. B41J 2/14

(52) U.S. Cl. CPC B41J 2/14274; B41J 2/1433; B41J 2002/14491

(57) ABSTRACT

A liquid discharge head includes: a nozzle plate having: multiple nozzle arrays each having multiple nozzles arrayed in a nozzle array direction; a channel plate having multiple individual chambers respectively communicating with the multiple nozzles; and a piezoelectric actuator including a single piezoelectric element, to deform each part of the multiple individual chambers to discharge a liquid in the multiple individual chambers from the multiple nozzles;
wherein the piezoelectric actuator includes multiple actuator arrays corresponding to the multiple nozzle arrays, each of the multiple actuator arrays including: multiple first portions not including internal electrodes in the single piezoelectric element; and multiple second portions including the internal electrodes in the single piezoelectric element, and the multiple second portions disposed at positions corresponding to the multiple nozzles.

### CROSS-REFERENCE TO RELATED APPLICATIONS

This patent application is based on and claims priority pursuant to 35 U.S.C. § 119(a) to Japanese Patent Application No. 2025-046063, filed on Mar. 19, 2025, in the Japan Patent Office, the entire disclosure of which is hereby incorporated by reference herein.

### BACKGROUND

### Technical Field

The present embodiment relates to a liquid discharge head and a liquid discharge apparatus.

### Related Art

In a piezoelectric actuator constituting a liquid discharge head, a piezoelectric element is grooved using dicing or a wire saw, and columns are formed so as to correspond to respective individual chambers.

### SUMMARY

The present disclosure disclosed herein provides a liquid discharge head includes: a nozzle plate having: multiple nozzle arrays each having multiple nozzles arrayed in a nozzle array direction; a channel plate having multiple individual chambers respectively communicating with the multiple nozzles; and a piezoelectric actuator including a single piezoelectric element, to deform each part of the multiple individual chambers to discharge a liquid in the multiple individual chambers from the multiple nozzles; wherein the piezoelectric actuator includes multiple actuator arrays corresponding to the multiple nozzle arrays, each of the multiple actuator arrays including: multiple first portions not including internal electrodes in the single piezoelectric element; and multiple second portions including the internal electrodes in the single piezoelectric element, the multiple second portions disposed at positions corresponding to the multiple nozzles, the multiple first portions and the multiple second portions are alternately arrayed in the nozzle array direction in each of the multiple actuator arrays, and the multiple actuator arrays in the single piezoelectric element respectively drive the multiple nozzle arrays.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic explanatory view of a printing apparatus according to an embodiment;

FIG. 2 is a plan explanatory view of a discharge unit of the printing apparatus;

FIG. 3 is an explanatory cross-sectional view in a direction orthogonal to a nozzle arrangement direction in an example of a head;

FIGS. 4A to 4C are views illustrating a piezoelectric actuator according to a comparative example;

FIG. 5 is a side view illustrating a configuration of the piezoelectric actuator according to the comparative example;

FIGS. 6A to 6D are views illustrating a configuration of a piezoelectric actuator;

FIG. 7 is a side view illustrating the configuration of the piezoelectric actuator;

FIG. 8 is a view illustrating an example of the configuration of the piezoelectric actuator; and

FIG. 9 is a view illustrating an example of the configuration of the piezoelectric actuator.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment of a liquid discharge head and a liquid discharge apparatus will be described in detail with reference to the accompanying drawings.

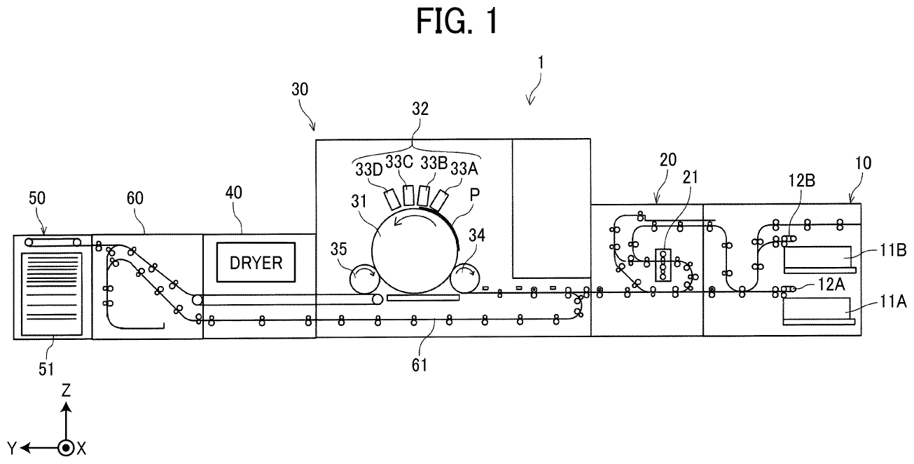

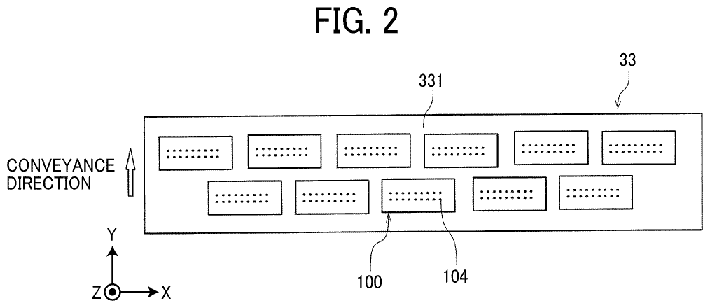

FIG. 1 is a schematic explanatory view of a printing apparatus 1 according to the embodiment, and FIG. 2 is a plan explanatory view of a discharge unit 33 of the printing apparatus 1.

The printing apparatus 1 is an apparatus that discharges liquid, and includes a carry-in unit 10 that carries in a sheet material P, a pretreatment unit 20, a printing unit 30, a drying unit 40, and a carry-out unit 50. The printing apparatus 1 applies (coats) pretreatment liquid to the sheet material P carried in (supplied) from the carry-in unit 10 as necessary by the pretreatment unit 20 that is a pretreatment unit, performs required printing by applying liquid by the printing unit 30, dries the liquid adhering to the sheet material P by the drying unit 40, and then discharges the sheet material P to the carry-out unit 50.

The carry-in unit 10 includes a carry-in tray 11 (a lower carry-in tray 11A, an upper carry-in tray 11B) that stores multiple sheet materials P and a feeding apparatus 12 (12A and 12B) that separates and feeds the sheet materials P one by one from the carry-in tray 11, and supplies the sheet materials P to the pretreatment unit 20.

The pretreatment unit 20 includes, for example, a coating unit 21 that is a treatment-liquid application unit that coats a printing surface of the sheet material P with treatment liquid having an effect of aggregation of ink particles and preventing bleed-through.

The printing unit 30 includes a drum 31 that is a carrying member (rotating member) that carries the sheet material P on a peripheral surface and rotates, and a liquid discharge device 32 that discharges liquid toward the sheet material P carried on the drum 31.

In addition, the printing unit 30 includes a delivery cylinder 34 that receives the sheet material P sent from the pretreatment unit 20 and delivers the sheet material P to the drum 31, and a delivery cylinder 35 that receives the sheet material P conveyed by the drum 31 and delivers the sheet material P to the drying unit 40.

A tip of the sheet material P conveyed from the pretreatment unit 20 to the printing unit 30 is gripped by a gripping unit (sheet gripper) provided in the delivery cylinder 34, and conveyed with rotation of the delivery cylinder 34. The sheet material P conveyed by the delivery cylinder 34 is delivered to the drum 31 at a position facing the drum 31.

A gripping unit (sheet gripper) is also provided on a surface of the drum 31, and the tip of the sheet material P is gripped by the gripping unit (sheet gripper). Multiple suction holes are dispersedly formed on the surface of the drum 31, and a suction airflow directed inward from required suction holes of the drum 31 is generated by a suction unit.

Then, the tip of the sheet material P delivered from the delivery cylinder 34 to the drum 31 is gripped by the sheet gripper, is sucked and carried on the drum 31 by the suction airflow by the suction unit, and is conveyed with the rotation of the drum 31.

The liquid discharge device 32 includes a discharge unit 33 (33A to 33D) as a liquid discharge unit. For example, the discharge unit 33A discharges cyan (C) liquid, the discharge unit 33B discharges magenta (M) liquid, the discharge unit 33C discharges yellow (Y) liquid, and the discharge unit 33D discharges black (K) liquid. In addition, it is also possible to use a discharge unit that discharges special liquid such as white or gold (silver).

For example, as illustrated in FIG. 2, the discharge unit 33 is a full-line type head in which multiple liquid discharge heads 100 having multiple nozzle rows in which multiple nozzles 104 are arranged is arranged in a staggered manner on a base 331. The liquid discharge head 100 may be referred to simply as a “head”. The multiple nozzles 104 is referred to also as “multiple nozzle holes”.

Discharge operation of each of the discharge units 33 of the liquid discharge device 32 is controlled by a drive signal corresponding to print information. When the sheet material P carried on the drum 31 passes through a region facing the liquid discharge device 32, the liquid of each color is discharged from the discharge unit 33, and an image corresponding to the print information is printed.

The drying unit 40 dries the liquid adhering to the sheet material P in the printing unit 30. As a result, liquid components such as moisture in the liquid are evaporated, a colorant contained in the liquid is fixed on the sheet material P, and curling of the sheet material P is reduced.

A reversing mechanism 60 is a mechanism that reverses the sheet material P by a switchback method when duplex printing is performed on the sheet material P that has passed through the drying unit 40, and the reversed sheet material P is reversely fed to an upstream side of the delivery cylinder 34 through a conveyance path 61 of the printing unit 30.

The carry-out unit 50 includes a carry-out tray 51 on which multiple sheet materials P are stacked. The sheet material P conveyed from the drying unit 40 via the reversing mechanism 60 is sequentially stacked and held on the carry-out tray 51.

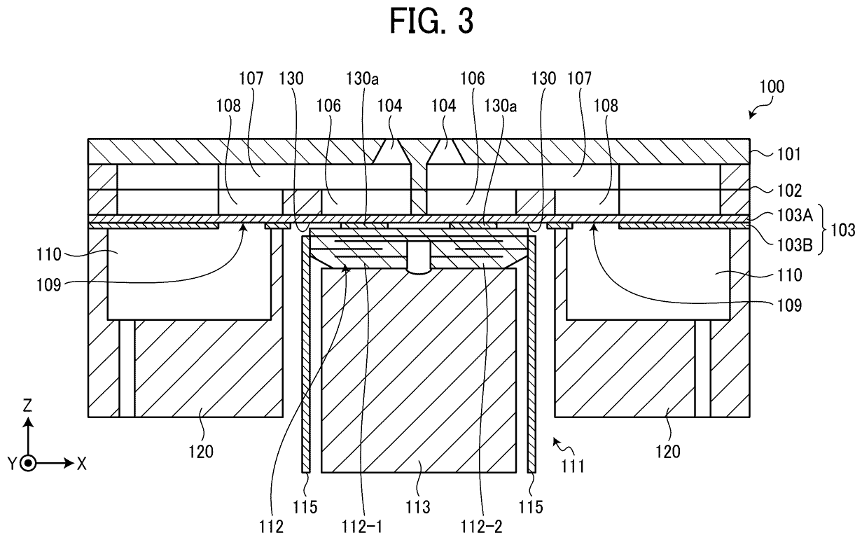

Next, an example of the head 100 will be described with reference to FIG. 3. FIG. 3 is an explanatory cross-sectional view in a direction orthogonal to a nozzle arrangement direction of the head.

The liquid discharge head 100 has a structure in which a nozzle plate 101, a channel plate 102 that is an individual channel member, and a diaphragm member 103 as a wall surface member are stacked and joined. The liquid discharge head further includes a piezoelectric actuator 111 that displaces a vibration region (diaphragm) 130 of the diaphragm member 103, and a common channel member 120 that also serves as a frame member of the head.

The nozzle plate 101 has multiple nozzle rows, which are multiple discharge arrays in which multiple nozzles 104 for discharging liquid are arranged in a nozzle array direction.

The channel plate 102 forms multiple pressure chambers (individual chambers) 106 communicating with the multiple nozzles 104, individual supply channels 107 also serving as fluid resistance portions respectively communicating with the pressure chambers 106, and intermediate supply channels 108 serving as liquid introduction portions communicating with two or more of the individual supply channels 107. The channel plate 102 is a liquid chamber member forming multiple pressure chambers (individual chambers) 106 respectively communicating with the nozzles 104.

The diaphragm member 103 includes multiple displaceable diaphragms (vibration regions 130) that form wall surfaces of the pressure chambers 106 of the channel plate 102. Here, the diaphragm member 103 has a two-layer structure (not limited), and includes a first layer 103A forming a thin portion and a second layer 103B forming a thick portion from the channel plate 102 side.

A deformable vibration region (diaphragm) 130 is formed in a portion corresponding to the pressure chamber 106 in the first layer 103A which is the thin portion. In the vibration region (diaphragm) 130, a convex portion 130a which is a thick portion to be joined to the piezoelectric actuator 111 in the second layer 103B is formed.

On the opposite side of the diaphragm member 103 from the pressure chamber 106, a piezoelectric actuator 111 including an electromechanical transducer element (piezoelectric element 112) as a drive unit (an actuator unit, a pressure generation element) that deforms the vibration region (diaphragm) 130 of the diaphragm member 103 is arranged.

In the piezoelectric actuator 111, the piezoelectric element 112 is joined onto the base 113. The piezoelectric element 112 is joined to the convex portion 130a which is the thick portion formed in the vibration region (diaphragm) 130 of the diaphragm member 103.

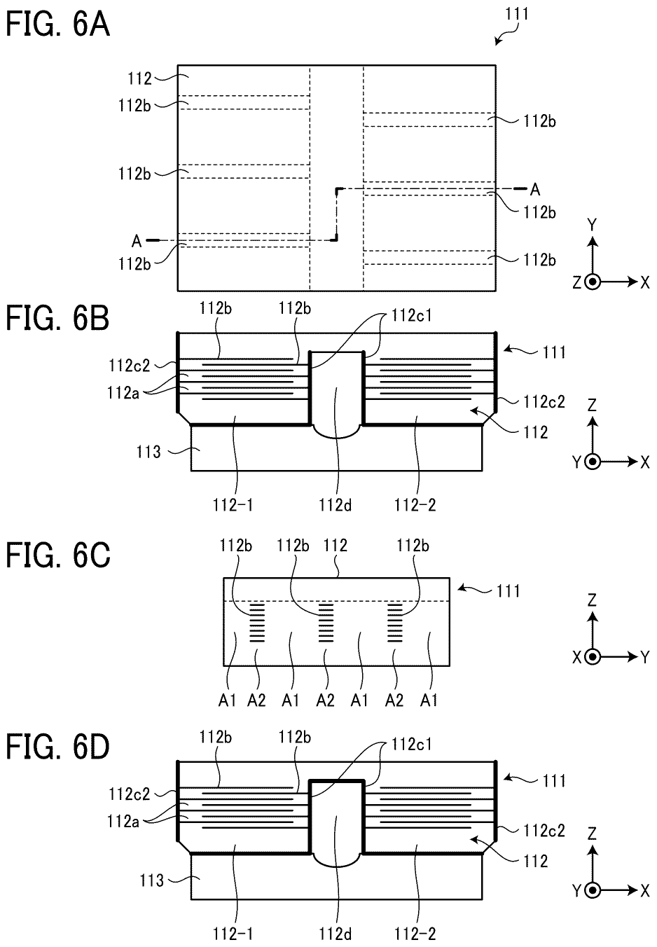

The piezoelectric element 112 is formed by alternately stacking piezoelectric layers 112a (see FIG. 6) and internal electrodes 112b (see FIG. 6), the internal electrodes 112b are respectively extended to end surfaces and connected to external electrodes (end face electrodes) 112c1 and 112c2 (see FIG. 6), and a flexible wiring member 115 is connected to the external electrode 112c2.

The common channel member 120 forms common supply channels (common chambers) 110. The common supply channels 110 communicate with the intermediate supply channels 108 serving as the liquid introduction portions via opening portions 109 also serving as filter portions provided in the diaphragm member 103, and communicate with the individual supply channels 107 via the intermediate supply channels 108.

In the liquid discharge head 100, for example, when a voltage to be applied to the piezoelectric element 112 is lowered from a reference potential (intermediate potential), the piezoelectric element 112 contracts, the vibration region (diaphragm) 130 of the diaphragm member 103 is pulled, and a volume of pressure chambers (individual chambers) 106 expands, so that the liquid flows into the pressure chambers 106.

Thereafter, the voltage to be applied to the piezoelectric element 112 is increased to extend the piezoelectric element 112 in a stacking direction, and the vibration region (diaphragm) 130 of the diaphragm member 103 is deformed in a direction toward the nozzles 104 to contract the volume of the pressure chambers (individual chambers) 106, so that the liquid in the pressure chambers (individual chambers) 106 is pressurized and the liquid is discharged from the nozzles 104.

Here, a piezoelectric actuator having a configuration of a comparative example will be described in detail.

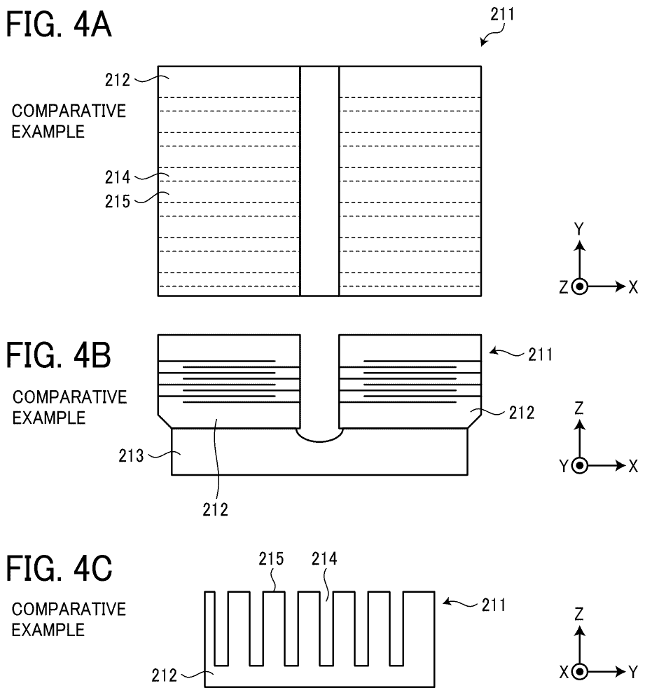

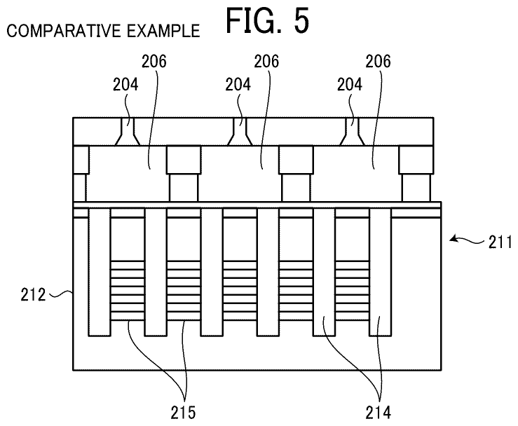

FIGS. 4A to 4C are views illustrating a configuration of a piezoelectric actuator 211 of a comparative example, and FIG. 5 is a side view of the configuration of the piezoelectric actuator 211 of the comparative example. FIG. 4A is a plan view, FIG. 4B is a cross-sectional view, and FIG. 4C is a side view as viewed from the right side of FIG. 4A. As illustrated in FIGS. 4A to 4C and 5, in the piezoelectric actuator 211 of the comparative example, a total of two piezoelectric elements 212, one for each nozzle row in which the nozzles 204 are arranged in a nozzle array direction, are joined to the base 213 in parallel, and then a groove portion 214 is formed by half-cut dicing, and the column portions 215 corresponding to the individual chambers are formed in a comb shape at predetermined intervals. As illustrated in FIG. 5, by joining the individual chambers 206 to the column portions 215, displacement can be generated only in the individual chambers.

However, in the liquid discharge head of the comparative example, the piezoelectric actuator 211 is configured by joining one piezoelectric element 212 to the base 213 for each discharge array, and thus, when the joined position of the piezoelectric element 212 deviates, a difference occurs in displacement generated in the individual chambers, and there is a problem that discharge quality varies.

Thus, in the present embodiment, the internal electrodes 112b of the piezoelectric actuator 111 are stacked only at positions corresponding to the multiple pressure chambers (individual chambers) 106, and multiple (here, two) discharge arrays are driven by the piezoelectric element 112 that is integrated.

Next, the piezoelectric actuator 111 will be described in detail.

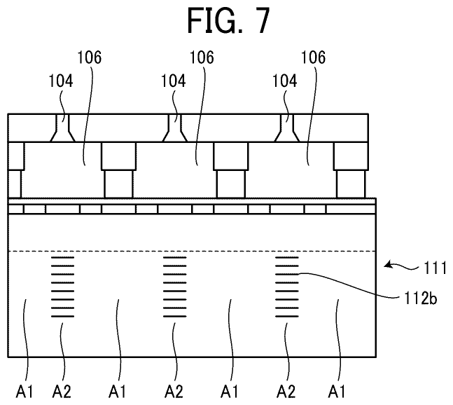

Here, FIGS. 6A to 6D are views illustrating a configuration of the piezoelectric actuator 111, and FIG. 7 is a side view of the piezoelectric actuator 111. FIG. 6A is a plan view, FIG. 6B is a cross-sectional view taken along a line A-A of FIG. 6A, FIG. 6C is a side view as viewed from the right side of FIG. 6A, and FIG. 6D is a plan view of a modification. However, in FIGS. 6C and 7, the external electrode 112c2 is omitted.

As illustrated in FIGS. 6A to 6D and 7, in the piezoelectric actuator 111, the piezoelectric element 112 in which two rows (112-1 and 112-2) are integrated is joined to the base 113. The rows (112-1 and 112-2) may be referred to as “actuator arrays”. The internal electrodes 112b are formed only at positions corresponding to the pressure chambers (individual chambers) 106, so that it is not necessary to separate the electrodes by dicing unlike the comparative example, and displacement can occur only in the pressure chambers (individual chambers) 106.

As illustrated in FIG. 6A, in the piezoelectric actuator 111, the internal electrodes 112b are arranged in a staggered manner. In this way, interference of displacement between individual drive channels can be reduced.

Note that as a distance between the internal electrodes 112b becomes shorter, the internal electrodes 112b of the piezoelectric actuator 111 become more susceptible to interference (crosstalk) due to displacement of the adjacent internal electrodes 112b. Thus, in order to reduce crosstalk, in the piezoelectric actuator 111, a shallow groove may be processed on a surface of the piezoelectric element 112.

As illustrated in FIGS. 6A and 6B, in the piezoelectric element 112, a groove portion 112d is formed on the joining surface side with the base 213 and inside the piezoelectric element 112. In other words, by the groove portion 112d, two element rows (actuator arrays 112-1 and 112-2) are formed in the piezoelectric element 112.

Further, as illustrated in FIG. 6B, the internal electrodes 112b exposed to the inside of the piezoelectric element 112 (the groove portion 112d side between the rows) and connected to the external electrode 112c1 and the internal electrode 112b exposed to the outside and connected to the external electrode 112c2 are alternately arranged. In the piezoelectric actuator 111, the external electrode 112c1 is formed on the groove portion 112d side to form a common electrode, and the external electrode 112c2 is formed on the outer side to form an individual electrode. In other words, the piezoelectric element 112 has the external electrode 112c2 for an individual electrode at a position on the outer side away from the groove portion 112d. As described above, by forming the external electrode 112c1 in the groove portion 112d, it is possible to control the individual internal electrodes 112b of each row.

As illustrated in FIGS. 6C and 7, the piezoelectric actuator 111 includes multiple rows (112-1 and 112-2) which correspond to multiple nozzle rows, and in which a first portion A1 including the piezoelectric element 112 and a second portion A2 including the piezoelectric element 112 and the internal electrode 112b are alternately arranged in a nozzle arrangement direction (nozzle array direction).

As illustrated in FIG. 6A, the internal electrodes 112b of the piezoelectric actuator 111 are arranged in a staggered manner, and thus, in the piezoelectric element 112, corresponding to the first portion A1 of one row 112-1 in the nozzle arrangement direction (nozzle array direction), the second portion A2 of another row 112-2 adjacent to the one row 112-1 is arranged. The rows 112-1 and 112-2 may be referred to as “actuator arrays”.

As illustrated in FIG. 6D, external electrodes 112c1 (common electrodes) of two rows (112-1 and 112-2) may be connected to form one common electrode in the two rows (112-1 and 112-2). In other words, the common electrode of one row 112-1 and the other row 112-2 is shared. In this way, a wiring, and the like, are simplified by sharing the common electrode between the two rows (112-1 and 112-2), so that space saving and cost reduction can be achieved.

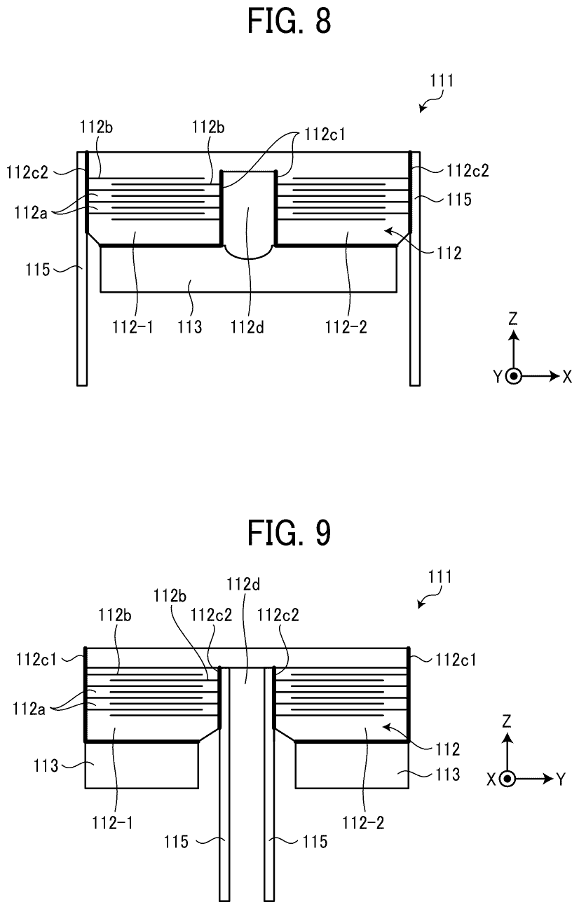

Here, FIG. 8 is a view illustrating an example of a configuration of the piezoelectric actuator 111.

As illustrated in FIG. 8, in the piezoelectric actuator 111, an IC is connected to the piezoelectric element 112 by joining a flexible wiring member 115 to an outer side surface (external electrode 112c2) of the piezoelectric element 112 by solder joint, or the like. The flexible wiring member 115 is a chip on flexible (COF), and
a semiconductor chip (driver IC) is mounted on a film-shaped wiring circuit board made of polyimide.

In addition, the external electrode 112c2 on the side surface of the piezoelectric actuator 111 adhering to the flexible wiring member 115 is formed only at a position corresponding to the individual internal electrode 112b using a mask during sputtering.

More specifically, the external electrodes 112c1 and 112c2 are formed by performing masking so that a film of the second portion A2 is formed and a film of at least part of the first portion A1 is not formed. This is because the external electrodes 112c1 and 112c2 also need to be formed only at the positions of the internal electrodes 112b in order to drive the internal electrodes 112b corresponding to the pressure chambers (individual chambers) 106.

In the piezoelectric actuator 111, the external electrode 112c1 formed in the groove portion 112d provided on the joining surface side between the piezoelectric element 112 and the base 113 is used as a common electrode.

In order to divide the external electrode 112c on the side surface of the piezoelectric actuator 111 into positions corresponding to the individual internal electrodes 112b, processing by a dicing saw may be performed so as to be electrically independent. This is because the external electrodes 112c also need to be formed only at the positions of the internal electrodes 112b in order to drive the internal electrodes 112b corresponding to the pressure chambers (individual chambers) 106.

In the configuration of the piezoelectric actuator 111, by stacking the internal electrodes 112b only at positions corresponding to the pressure chambers (individual chambers) 106, it is possible to drive the respective pressure chambers (individual chambers) 106 without processing by a dicing saw. In addition, as a result of processing with a dicing saw being not performed, defects caused by the processing are eliminated, and the effect of improving a yield can be obtained. Furthermore, a risk of increasing a size of the piezoelectric element 112 (deterioration in yield, or the like) is reduced by not performing processing with a dicing saw, and thus, while in the configuration of the comparative example, each discharge array is driven by one piezoelectric element 112, it is possible to employ a configuration in which multiple (two) discharge arrays are driven by the piezoelectric element 112 that is integrated.

As described above, by driving multiple (two) discharge arrays by the piezoelectric element 112 that is integrated, it is possible to eliminate decrease in discharge quality due to deviation in a joining position of the piezoelectric element 112 and variation in discharge quality due to individual differences in electrical characteristics of the piezoelectric element 112.

In the present embodiment, as illustrated in FIG. 8, in the piezoelectric actuator 111, the flexible wiring member 115 is joined to the outer side surface (external electrode 112c2) of the piezoelectric element 112 by solder joint, or the like, but the present invention is not limited thereto. Here, FIG. 9 is a view illustrating an example of a configuration of the piezoelectric actuator 111.

As illustrated in FIG. 9, in the piezoelectric actuator 111, two bases 113 may be provided, the individual internal electrodes 112b may be provided between the bases 113, and the flexible wiring member 115 may be joined to the inner side surfaces (external electrodes 112c) of the piezoelectric element 112 between the bases 113.

In a case where a width between the inner side surfaces of the piezoelectric element 112 is wide, it is easier to apply a pressure by joining the flexible wiring member 115 to the inner side surfaces of the piezoelectric element 112 than to the outer side surface of the piezoelectric element 112, and an adhesive method such as ACF can be adopted.

In the present application, the liquid to be discharged is not particularly limited as long as it has a viscosity and surface tension that can be discharged from the head, but it is preferable that the viscosity is 30 mPa·s or less at normal temperature and normal pressure, or by heating or cooling. More specifically, the liquid is a solution, a suspension, an emulsion, or the like, containing a solvent such as water or an organic solvent, a colorant such as a dye or a pigment, a functionalizing material such as a polymerizable compound, a resin, or a surfactant, a biocompatible material such as DNA, amino acid, protein, or calcium, an edible material such as a natural pigment, or the like, and these can be used for, for example, an inkjet ink, a surface treatment liquid, a liquid for forming a constituent element of an electronic element or a light emitting element or an electronic circuit resist pattern, a material liquid for three-dimensional modeling, or the like.

Examples of an energy generation source that discharges a liquid include a piezoelectric actuator (a stacked piezoelectric element and a thin film piezoelectric element), a thermal actuator using an electrothermal transducer such as a heating resistor, and an electrostatic actuator including a diaphragm and a counter electrode.

The “liquid discharge unit” is formed by integrating a functional component and a mechanism with the liquid discharge head, and includes an assembly of components related to liquid discharge. For example, the “liquid discharge unit” includes a combination of the liquid discharge head and at least one of components of a head tank, a carriage, a supply mechanism, a maintenance/recovery mechanism, a main scanning movement mechanism, and a liquid circulation apparatus.

Here, the integration includes, for example, a configuration in which the liquid discharge head, the functional component, and the mechanism are fixed to each other by fastening, adhesion, engagement, or the like, and a configuration in which one is movably held with respect to the other. Further, the liquid discharge head, the functional component, and the mechanism may be detachable from each other.

For example, as the liquid discharge unit, there is a unit in which the liquid discharge head and the head tank are integrated. Further, there is a unit in which the liquid discharge head and the head tank are integrally connected to each other by a tube, or the like. Here, a unit including a filter can be added between the head tank and the liquid discharge head of the liquid discharge unit.

Further, as the liquid discharge unit, there is a unit in which the liquid discharge head and the carriage are integrated.

Further, as the liquid discharge unit, there is a unit in which the liquid discharge head is movably held by a guide member constituting part of the scanning movement mechanism, and the liquid discharge head and the scanning movement mechanism are integrated. Further, there is a unit in which the liquid discharge head, the carriage, and the main scanning movement mechanism are integrated.

Further, as the liquid discharge unit, there is a unit in which a cap member that is part of the maintenance/recovery mechanism is fixed to the carriage to which the liquid discharge head is attached, and the liquid discharge head, the carriage, and the maintenance/recovery mechanism are integrated.

Further, as the liquid discharge unit, there is a unit in which a tube is connected to the liquid discharge head to which the head tank or a channel component is attached, and the liquid discharge head and the supply mechanism are integrated. Liquid in a liquid storage source is supplied to the liquid discharge head through the tube.

The main scanning movement mechanism also includes a single guide member. The supply mechanism also includes a single tube and a single loading unit.

The “liquid discharge apparatus” includes an apparatus that includes the liquid discharge head or the liquid discharge unit and drives the liquid discharge head to discharge liquid. Examples of the liquid discharge apparatus include not only an apparatus capable of discharging liquid to an object to which the liquid can adhere but also an apparatus that discharges liquid toward air or liquid.

The “liquid discharge apparatus” may also include units related to feeding, conveying, and sheet ejection of an object to which the liquid can adhere, a pretreatment apparatus, a post-treatment apparatus, and the like.

For example, examples of the “liquid discharge apparatus” include an image forming apparatus that discharges ink to form an image on a sheet, and a stereoscopic fabrication apparatus (three-dimensional fabrication apparatus) that discharges fabrication liquid to a powder layer obtained by forming powder into a layer in order to fabricate a stereoscopic fabrication object (three-dimensional fabrication object).

In addition, the “liquid discharge apparatus” is not limited to an apparatus in which a meaningful image such as a character or a figure is visualized by the discharged liquid. For example, the “liquid discharge apparatus” includes an apparatus that forms a meaningless pattern, or the like, and an apparatus that forms a three-dimensional image.

The “object to which the liquid can adhere” means an object to which the liquid can at least temporarily adhere, an object to which the liquid adheres and is fixed, an object to which the liquid adheres and permeates, or the like. Specific examples include a recording medium such as a paper sheet, recording paper, a recording paper sheet, a film, and cloth, an electronic component such as an electronic substrate and a piezoelectric element, and a medium such as a powder layer (powder layer), an organ model, and an inspection cell, and include all those to which the liquid adheres unless otherwise specified.

Examples of materials for the “object to which the liquid can adhere” include any materials to which the liquid can adhere even temporarily, such as paper, thread, fiber, fabric, leather, metal, plastic, glass, wood, and ceramic.

Further, the “liquid discharge apparatus” may be an apparatus in which the liquid discharge head and the object to which the liquid can adhere move relative to each other, but is not limited thereto. Specific examples include a serial type apparatus that moves the liquid discharge head, a line type apparatus that does not move the liquid discharge head, and the like.

Examples of the “liquid discharge apparatus” further include a treatment liquid application apparatus that discharges treatment liquid onto a sheet in order to apply the treatment liquid to a surface of the sheet for the purpose of modifying the surface of the sheet, and an injection granulation apparatus that injects composition liquid in which a raw material is dispersed in a solution through a nozzle to granulate fine particles of the raw material.

Note that, in the terms of the present application, image formation, recording, printing out, image printing, printing, shaping, and the like, are all synonymous.

According to the present embodiment, it is possible to prevent decrease in discharge quality due to deviation in a joining position of a piezoelectric element and variation in discharge quality due to individual differences in electrical characteristics of the piezoelectric element.

A liquid discharge head includes: a nozzle plate (101) having: multiple nozzle arrays each having multiple nozzles (104) arrayed in a nozzle array direction; a channel plate (102) having multiple individual chambers (106) respectively communicating with the multiple nozzles (104); and a piezoelectric actuator (111) including a single piezoelectric element (112), to deform each part of the multiple individual chambers (106) to discharge a liquid in the multiple individual chambers (106) from the multiple nozzles (104), wherein the piezoelectric actuator (111) includes multiple actuator arrays (112-1, 112-2) corresponding to the multiple nozzle arrays, each of the multiple actuator arrays (112-1, 112-2) including: multiple first portions (A1) not including internal electrodes (112b) in the single piezoelectric element (112); and multiple second portions (A2) including the internal electrodes (112b) in the single piezoelectric element (112), the multiple second portions (A2) disposed at positions corresponding to the multiple nozzles (104), the multiple first portions (A1) and the multiple second portions (A2) are alternately arrayed in the nozzle array direction in each of the multiple actuator arrays (112-1, 112-2), and the multiple actuator arrays (112-1, 112-2) in the single piezoelectric element are respectively driven to discharge the liquid from the multiple nozzle arrays.

Each of the multiple second portions of the multiple actuator arrays (112-1, 112-2) in the single piezoelectric element are respectively driven to discharge the liquid from the multiple nozzle arrays.

The piezoelectric actuator (111) further includes: a base (113) joined to a joining surface of the single piezoelectric element (112), the single piezoelectric element (112) having a groove (112d) on the joining surface; and an external electrode (112c1) functioning as a common electrode in the groove (112d). The multiple actuator arrays (112-1, 112-2) includes: a first actuator array (112-1); and a second actuator array (112-2) adjacent to the first actuator array (112-1) in a transverse direction orthogonal to the nozzle array direction, and one of the multiple first portions (A1) of the first actuator array (112-1) is disposed at same position with one of the multiple second portions (A2) of the second actuator array (112-2) in the nozzle array direction.

The multiple actuator arrays (112-1, 112-2) includes: a first actuator array (112-1); and a second actuator array (112-2) adjacent to the first actuator array (112-1) in a transverse direction orthogonal to the nozzle array direction, the groove is disposed between the first actuator array (112-1) and the second actuator array (112-2) in the transverse direction, and the piezoelectric actuator (111) includes another external electrode functioning as an individual electrode at each of outer side surfaces of the single piezoelectric element in the transverse direction.

The multiple actuator arrays (112-1, 112-2) includes: a first actuator array (112-1); and a second actuator array (112-2) adjacent to the first actuator array (112-1) in a transverse direction orthogonal to the nozzle array direction, the external electrode (112c1) in the groove (112d) includes: a first external electrode (112c1) on an inner side face of the first actuator array (112-1); a second external electrode (112c1) on an inner side face of the second actuator array (112-2), a second external electrode is connected to the first external electrode; and a connection external electrode (112c1) on a bottom surface of the groove (112d), the connection external electrode connecting the first external electrode and the second external electrode.

The single piezoelectric element includes the internal electrodes (112b) arranged in a staggered manner in the single piezoelectric element (112) in a plan view of the piezoelectric actuator (111). The piezoelectric actuator (111): includes said another external electrode at positions corresponding to the multiple second portions on the outer side surfaces of the single piezoelectric element in the nozzle array direction; and does not include said another external electrode at positions corresponding to the multiple first portions on the outer side surfaces of the single piezoelectric element in the nozzle array direction. Said another external electrode has multiple cuts at positions corresponding to the multiple first portions in the single piezoelectric element on the outer side surfaces.

A liquid discharge apparatus includes: a conveyor to convey a medium; and the liquid discharge head to discharge the liquid onto the medium conveyed by the conveyor.

Aspects of the present embodiment are, for example, as follows.

According to a first aspect, a liquid discharge head includes:
a nozzle plate having multiple discharge arrays in which multiple nozzles for discharging liquid are arranged in a nozzle array direction;
a liquid chamber member forming multiple individual chambers respectively communicating with the nozzles; and
a piezoelectric actuator that includes a piezoelectric element and pressurizes liquid in the individual chambers,
the piezoelectric actuator including multiple rows corresponding to the multiple discharge arrays, in which a first portion including the piezoelectric element, and a second portion including the piezoelectric element and internal electrodes are alternately arranged in the nozzle array direction, and
the multiple discharge arrays being driven by the piezoelectric element that is integrated.

According to a second aspect, in the liquid discharge head of the first aspect,
the piezoelectric element forms a groove portion on a joining surface side of the piezoelectric actuator with a base, and
in the piezoelectric actuator, an external electrode is formed in the groove portion to form a common electrode.

According to a third aspect, in the liquid discharge head of the first aspect or the second aspect, in the piezoelectric element, corresponding to the first portion of one row among the rows in the nozzle array direction, the second portion of another row adjacent to the one row is arranged.

According to a fourth aspect, in the liquid discharge head of the second aspect,
a film of the external electrode constituting the piezoelectric actuator is formed by sputtering when the external electrode is formed on a side surface of the piezoelectric actuator, and
the external electrode is formed by performing masking so that a film of the second portion is formed, and a film of at least part of the first portion is not formed.

According to a fifth aspect, in the liquid discharge head of the second aspect, the external electrode of the piezoelectric actuator is diced to be electrically independent to be divided into positions corresponding to the individual internal electrodes when formed on a side surface of the piezoelectric actuator.

According to a sixth aspect, in the liquid discharge head of the second aspect,
the groove portion is provided between one row and another row among the rows, and
the piezoelectric element includes an external electrode for an individual electrode at a position on an outer side away from the groove portion.

According to a seventh aspect, in the liquid discharge head of the second aspect, a common electrode of one row and another row among the rows is shared.

According to an eighth aspect, a liquid discharge apparatus includes
the liquid discharge head of any one of the first aspect to the seventh aspect,
the liquid discharge head being driven to discharge liquid.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
multiple nozzle arrays each having multiple nozzles arrayed in a nozzle array direction;
a channel plate having multiple individual chambers respectively communicating with the multiple nozzles; and
a piezoelectric actuator including a single piezoelectric element,
to deform each part of the multiple individual chambers to discharge a liquid in the multiple individual chambers from the multiple nozzles;
wherein the piezoelectric actuator includes multiple actuator arrays corresponding to the multiple nozzle arrays,
each of the multiple actuator arrays including:
multiple first portions not including internal electrodes in the single piezoelectric element; and
multiple second portions including the internal electrodes in the single piezoelectric element, the multiple second portions disposed at positions corresponding to the multiple nozzles,
the multiple first portions and the multiple second portions are alternately arrayed in the nozzle array direction in each of the multiple actuator arrays, and
the multiple actuator arrays in the single piezoelectric element are respectively driven to discharge the liquid from the multiple nozzle arrays.

2. The liquid discharge head according to claim 1,
wherein each of the multiple second portions of the multiple actuator arrays in the single piezoelectric element are respectively driven to discharge the liquid from the multiple nozzle arrays.

3. The liquid discharge head according to claim 1,
wherein the piezoelectric actuator further includes:
a base joined to a joining surface of the single piezoelectric element,
the single piezoelectric element having a groove on the joining surface; and
an external electrode functioning as a common electrode in the groove.

4. The liquid discharge head according to claim 1,
wherein the multiple actuator arrays includes:
a first actuator array; and
a second actuator array adjacent to the first actuator array in a transverse direction orthogonal to the nozzle array direction, and
one of the multiple first portions of the first actuator array is disposed at same position with one of the multiple second portions of the second actuator array in the nozzle array direction.

5. The liquid discharge head according to claim 3,
wherein the multiple actuator arrays includes:
a first actuator array; and
a second actuator array adjacent to the first actuator array in a transverse direction orthogonal to the nozzle array direction,
the groove is disposed between the first actuator array and the second actuator array in the transverse direction, and
the piezoelectric actuator includes another external electrode functioning as an individual electrode at each of outer side surfaces of the single piezoelectric element in the transverse direction.

6. The liquid discharge head according to claim 3,
wherein the multiple actuator arrays includes:
a first actuator array; and
a second actuator array adjacent to the first actuator array in a transverse direction orthogonal to the nozzle array direction,
the external electrode in the groove includes:
a first external electrode on an inner side face of the first actuator array;
a second external electrode on an inner side face of the second actuator array, a second external electrode is connected to the first external electrode; and
a connection external electrode on a bottom surface of the groove, the connection external electrode connecting the first external electrode and the second external electrode.

7. The liquid discharge head according to claim 1,
wherein the single piezoelectric element includes the internal electrodes arranged in a staggered manner in the single piezoelectric element in a plan view of the piezoelectric actuator.

8. The liquid discharge head according to claim 5,
wherein the piezoelectric actuator:
includes said another external electrode at positions corresponding to the multiple second portions on the outer side surfaces of the single piezoelectric element in the nozzle array direction; and
does not include said another external electrode at positions corresponding to the multiple first portions on the outer side surfaces of the single piezoelectric element in the nozzle array direction.

9. The liquid discharge head according to claim 5,
wherein said another external electrode has multiple cuts at positions corresponding to the multiple first portions in the single piezoelectric element on the outer side surfaces.

10. A liquid discharge apparatus comprising:
a conveyor to convey a medium; and
the liquid discharge head according to claim 1 to discharge the liquid onto the medium conveyed by the conveyor.
